(19) United States
(12) Patent Application Publication
(10) Pub. No.: US 2019/0184832 A1
(43) Pub. Date: Jun. 20, 2019

(54) VEHICLE POWER SYSTEM WITH BACK ELECTROMAGNETIC FIELD BLOCKING

(71) Applicant: Ford Global Technologies, LLC, Dearborn, MI (US)

(72) Inventors: Hadi Malek, Dearborn, MI (US); Ali Najmabadi, Ferndale, MI (US); Arshan Khan, Canton, MI (US)

(21) Appl. No.: 15/847,185

(22) Filed: Dec. 19, 2017

(51) Int. Cl. B60L 3/00; B60L 7/14; B60L 15/00; H02P 27/06

(52) U.S. Cl. CPC B60L 3/0061; B60L 7/14; B60L 15/007; H02M 7/537; B60L 2240/529; B60L 2260/26; Y10S 903/903; H02P 27/06

(57) ABSTRACT

A vehicle power system includes an electric machine, an inverter, and a plurality of pairs of switches and associated anti-parallel diodes electrically between the electric machine and inverter. Each of the pairs permits current flow from the inverter to the electric machine with activation of the switch, and prevents current flow from the electric machine to the inverter without activation of the switch.

### TECHNICAL FIELD

This disclosure relates to electric drive systems for automotive vehicles.

### BACKGROUND

Hybrid-electric vehicles (HEVs) and battery electric vehicles (BEVs) may rely on a traction battery to provide power to a traction motor for propulsion, and a power inverter therebetween to convert direct current (DC) power to alternating current (AC) power. The typical AC traction motor is a three-phase motor powered by three sinusoidal signals each driven with 120 degrees phase separation. Also, many electrified vehicles may include a DC-DC converter to convert the voltage of the traction battery to an operational voltage level of the traction motor.

### SUMMARY

A vehicle power system includes an electric machine configured to drive vehicle wheels, an inverter, and a switching arrangement. The switching arrangement is coupled between the electric machine and inverter, and is configured to permit current flow from the inverter to the electric machine with activation of elements of the switching arrangement, and to prevent current flow from the electric machine to the inverter without activation of the elements.

A vehicle power system includes an electric machine, an inverter, and a plurality of pairs, each including a switch and an associated anti-parallel diode, electrically between the electric machine and inverter. Each of the pairs is configured to permit current flow from the inverter to the electric machine with activation of the switch, and to prevent current flow from the electric machine to the inverter without activation of the switch.

A method for operating a vehicle power system includes, by a controller, permitting activation of switches of a switching arrangement coupled between an electric machine and inverter to permit current flow from the inverter to the electric machine, and preventing activation of the switches to block back electromagnetic fields associated with the electric machine from the inverter.

### BRIEF DESCRIPTION OF THE DRAWINGS

FIGS. 1 and 2 are schematic diagrams of vehicles including electrified powertrains.

### DETAILED DESCRIPTION

Various embodiments of the present disclosure are described herein. However, the disclosed embodiments are merely exemplary and other embodiments may take various and alternative forms that are not explicitly illustrated or described. The figures are not necessarily to scale; some features may be exaggerated or minimized to show details of particular components. Therefore, specific structural and functional details disclosed herein are not to be interpreted as limiting, but merely as a representative basis for teaching one of ordinary skill in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, may be desired for particular applications or implementations.

An input capacitor (DC capacitor) is a common element found in a DC-AC inverter. This component stores a sufficient amount of energy that can be accessed and transferred to the load during each switching cycle. The flipside of having this storage is that the stored energy can create issues if not depleted in a timely manner when the DC-AC inverter is not operational. The internal series resistance of the DC capacitor is often not large enough to dissipate the energy in a short period of time. In some circumstances, the voltage of the DC capacitor should reach 60 V in approximately 60 seconds. For this reason, there is often an additional dissipative component (e.g., resistor) in parallel with the capacitor. The value of this resistor can be calculated according to the following equation:

t=−RC ln(V_{acceptable}/Vₘₐₓ)

where R and C are the resistor and capacitor values, V_{acceptable} is the acceptable voltage (e.g., 60 V), Vₘₐₓ is the maximum voltage seen by the DC capacitor, and t is the time for the DC capacitor voltage to go form Vₘₐₓ to V_{acceptable}.

According to this equation, the smaller the resistor value, R, the shorter the discharge time, t. Thus, one may conclude that having a small resistor value, R, resolves the issue and will bring the voltage down in a reasonable time. This, however, may not be the case for the following reasons: (1) By reducing the resistor value, R, the power loss, Pₗₒₛₛ=V²/R, will increase for a constant voltage. Because this power loss converts to thermal load, the cooling system will work harder to remove this extra heat. (2) Since high power (high wattage) resistors are standard packs with standard values, smaller and smaller resistor values sometimes translate to more resistors in parallel, which adds to packaging complexity.

The above issues may be exacerbated during flat tow. In this case, the back electromagnetic fields generated by the motor may charge the DC capacitor. This charge should be dissipated once the vehicle stops. If we assume that the DC capacitor is 1000 uF, the required resistor value to deplete the DC capacitor charge may be 26 kΩ, which may result in approximately 13 W of continuous power loss. Heat may build up as a result, particularly in circumstances in which the cooling system is not operable, such as during flat tow. Some vehicle manufacturers approach the flat tow issue by specifying trailer tow requirements instead. In such cases, the discharge resistors may be designed for normal operation only.

The above issues may also be exacerbated during downhill travel as back electromagnetic fields generated by the motor may charge the DC capacitor. Some vehicle manufacturers use specific switching algorithms to circulate current trough the motor windings to dissipate the power. Although this methodology may be effective, it may increase losses due to switching. Here, various arrangements of diodes and/or switching elements are contemplated that block reverse currents from unwanted charging.

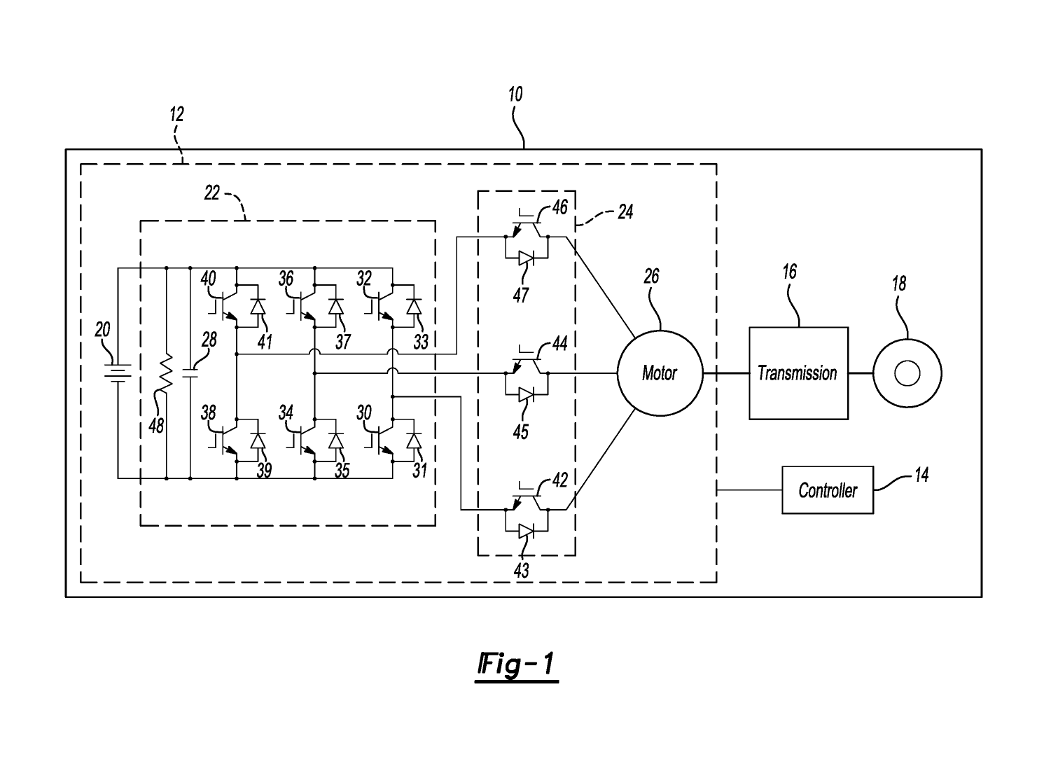

With reference to FIG. 1, vehicle 10 includes electrified powertrain 12, controller 14, transmission 16, and wheels 18. The electrified powertrain 12 includes traction battery 20, inverter 22, switch pack 24, and electric machine 26. As indicated by heavy solid line, the electric machine 26 is mechanically coupled with the transmission 16, and the transmission 16 is mechanically coupled with the wheels 18. Thus, mechanical power developed by the electric machine 26 can be transferred to the wheels 18 via the transmission 16.

The inverter 22 includes capacitor 28 and switches 30, 32, 34, 36, 38, 40. Each of the switches is paired with a corresponding anti-parallel diode 31, 33, 35, 37, 39, 41 respectively. The capacitor 28, switches and diodes 30-41 are arranged in usual fashion with the capacitor 28 being electrically in parallel with the traction battery 20, and electrically between the traction battery 20 and switches and diodes 30-41. In this example, the electric machine 26 is a three-phase electric machine. As such, the switch pack 24 includes a trio of switches 42, 44, 46 each paired with a corresponding anti-parallel diode 43, 45, 47 respectively.

Each of the three pairs of switches and anti-parallel diodes is electrically in series with a phase of the electric machine 26 and a mid-point of a leg of the inverter 22. This arrangement permits the switch pack 24 to permit AC current flow between the inverter 22 and electric machine 26 with selective activation of the switches 42, 44, 46. The controller 14, for example, may control the inverter 22 and switch pack 24 during a propulsion mode such that current from the traction battery 20 flows through the activated switch 40, the anti-parallel diode 47 to a phase of the electric machine 26, and through the activated switches 42, 30 returning to the traction battery 20 without activation of the switch 46. The controller 14, for example, may control the inverter 22 and switch pack 24 during a regenerative mode such that current from a phase of the electric machine 26 flows through the activated switch 46 and the anti-parallel diode 41 to the traction battery 20, and the anti-parallel diodes 31, 43 returning to the electric machine 26. These methodologies can, of course, be extended to all the phases. This arrangement also permits the switch pack 24 to prevent current flow from the electric machine 26 to the inverter 22 without activation of the switches 42, 44, 46 by virtue of the anti-parallel diodes 43, 45, 47. This, for example, may be responsive to a tow mode or downhill travel mode. Thus, this arrangement permits the switch pack 24 to passively block currents associated with back electromagnetic fields associated with the electric machine 26 from the inverter 22.

The switch pack 24 may also be used in concert with the inverter 22 and electric machine 26 to discharge the capacitor 28. The controller 14, for example, may operate the switches 30, 40, 42 such that current circulates between the inverter 22 and windings of the electric machine 26.

The inverter 22, in certain examples, may include a resistor 48 in parallel with and electrically between the traction battery 20 and capacitor 28. Thus the controller 14, for example, may operate the inverter 22 and switch pack 24 to direct current from the motor 26 to the resistor 48 to discharge the same assuming for example that the usual contactors (not shown) between the traction battery 20 and inverter 22 are open.

The architecture of FIG. 1 is but one example. Others, of course, are also contemplated. The electric machine 26 may have a different number of phases. And the switch pack 24 may include a corresponding different number of switches and anti-parallel diode pairs. Possible switch types include IGBTs, MOSFETs, thyristors, etc.

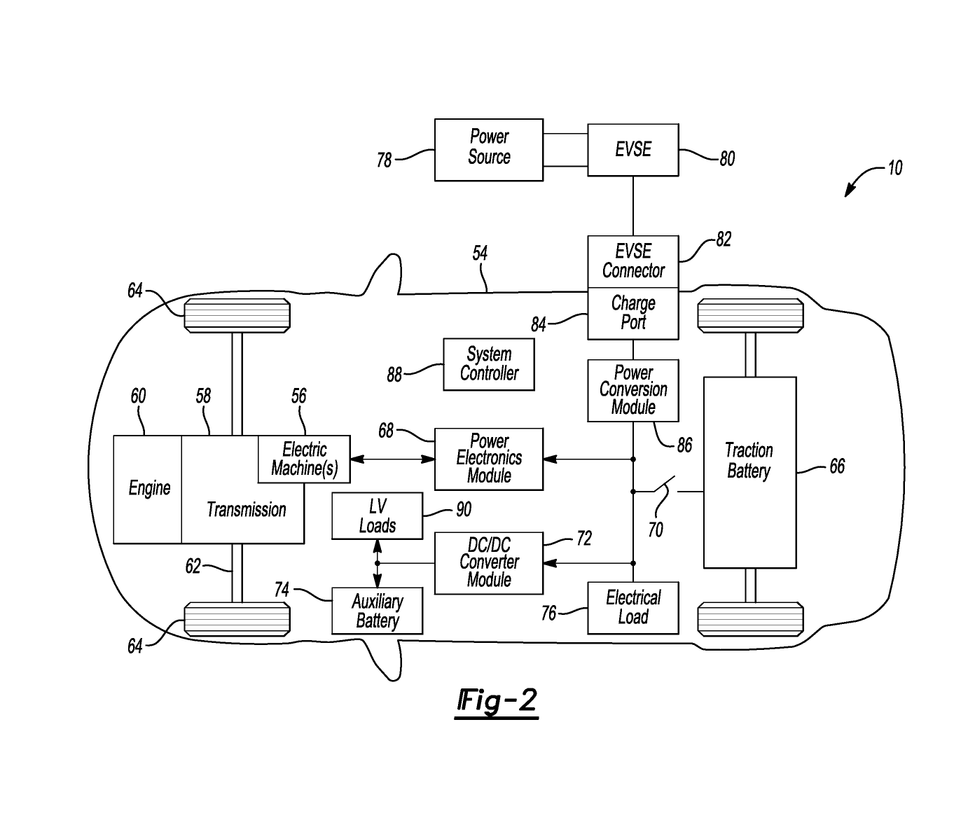

The architectures contemplated herein may be implemented within a variety of vehicle configurations. FIG. 2, for example, depicts an electrified vehicle 54 that includes one or more electric machines 56 mechanically coupled to a hybrid transmission 58. The electric machines 56 may operate as a motor or generator. In addition, the hybrid transmission 58 is mechanically coupled to an engine 60 and a drive shaft 62 that is mechanically coupled to the wheels 64.

A traction battery or battery pack 66 stores energy that can be used by the electric machines 56. The vehicle battery pack 66 may provide a high voltage direct current (DC) output. The traction battery 66 may be electrically coupled to one or more power electronics modules 68 that implement the architectures discussed above. One or more contactors 70 may isolate the traction battery 66 from other components when opened and connect the traction battery 66 to other components when closed. The power electronics module 68 is also electrically coupled to the electric machines 56 and provides the ability to bi-directionally transfer energy between the traction battery 66 and the electric machines 56. For example, the traction battery 66 may provide a DC voltage while the electric machines 56 may operate with a three-phase alternating current (AC) to function. The power electronics module 68 may convert the DC voltage to a three-phase AC current to operate the electric machines 56. In a regenerative mode, the power electronics module 68 may convert the three-phase AC current from the electric machines 56 acting as generators to the DC voltage compatible with the traction battery 66.

The vehicle 54 may include a variable-voltage converter (VVC) (not shown) electrically coupled between the traction battery 66 and power electronics module 68. The VVC may be a DC/DC boost converter configured to increase or boost the voltage provided by the traction battery 66. By increasing the voltage, current requirements may be decreased leading to a reduction in wiring size for the power electronics module 68 and the electric machines 56. Further, the electric machines 56 may be operated with better efficiency and lower losses.

In addition to providing energy for propulsion, the traction battery 66 may provide energy for other vehicle electrical systems. The vehicle 54 may include a DC/DC converter module 72 that converts the high voltage DC output of the traction battery 66 to a low voltage DC supply that is compatible with low-voltage vehicle loads. An output of the DC/DC converter module 72 may be electrically coupled to an auxiliary battery 74 (e.g., 12V battery) for charging the auxiliary battery 74. The low-voltage systems may be electrically coupled to the auxiliary battery 74. One or more electrical loads 76 may be coupled to the high-voltage bus. The electrical loads 76 may have an associated controller that operates and controls the electrical loads 76 when appropriate. Examples of electrical loads 76 may include a fan, an electric heating element, and/or an air-conditioning compressor.

The electrified vehicle 54 may be configured to recharge the traction battery 66 from an external power source 78. The external power source 78 may be a connection to an electrical outlet. The external power source 78 may be electrically coupled to a charger or electric vehicle supply equipment (EVSE) 80. The external power source 78 may be an electrical power distribution network or grid as provided by an electric utility company. The EVSE 80 may provide circuitry and controls to regulate and manage the transfer of energy between the power source 78 and the vehicle 54. The external power source 78 may provide DC or AC electric power to the EVSE 80. The EVSE 80 may have a charge connector 82 for plugging into a charge port 84 of the vehicle 54. The charge port 84 may be any type of port configured to transfer power from the EVSE 80 to the vehicle 54. The charge port 84 may be electrically coupled to a charger or on-board power conversion module 86. The power conversion module 86 may condition the power supplied from the EVSE 80 to provide the proper voltage and current levels to the traction battery 66. The power conversion module 86 may interface with the EVSE 80 to coordinate the delivery of power to the vehicle 54. The EVSE connector 82 may have pins that mate with corresponding recesses of the charge port 84. Alternatively, various components described as being electrically coupled or connected may transfer power using a wireless inductive coupling.

In some configurations, the electrified vehicle 54 may be configured to provide power to an external load. For example, the electrified vehicle may be configured to operate as a back-up generator or power outlet. In such applications, a load may be connected to the EVSE connector 82 or other outlet. The electrified vehicle 54 may be configured to return power to the power source 78. For example, the electrified vehicle 54 may be configured to provide alternating current (AC) power to the electrical grid. The voltage supplied by the electrified vehicle may be synchronized to the power line.

Electronic modules in the vehicle 54 may communicate via one or more vehicle networks. The vehicle network may include a plurality of channels for communication. One channel of the vehicle network may be a serial bus such as a Controller Area Network (CAN). One of the channels of the vehicle network may include an Ethernet network defined by the Institute of Electrical and Electronics Engineers (IEEE) 802 family of standards. Additional channels of the vehicle network may include discrete connections between modules and may include power signals from the auxiliary battery 74. Different signals may be transferred over different channels of the vehicle network. For example, video signals may be transferred over a high-speed channel (e.g., Ethernet) while control signals may be transferred over CAN or discrete signals. The vehicle network may include any hardware and software components that aid in transferring signals and data between modules. The vehicle network is not shown but it may be implied that the vehicle network may connect to any electronic module that is present in the vehicle 54. A vehicle system controller (VSC) 88 may be present to coordinate the operation of the various components.

As depicted, the vehicle 54 may include the power conversion module 86 for transferring power from the external power source 78 to a high-voltage bus of the vehicle 54. The vehicle 54 also includes the DC/DC converter module 72 for converting the voltage of the high-voltage bus to a voltage level suitable for the auxiliary battery 74 and low-voltage loads 90 (e.g., around 12 Volts). The vehicle 54 may further include additional switches, contactors, and circuitry to selectively select power flow between the traction battery 66 to the DC/DC converter 72 and/or between the power conversion module 86 and the traction battery 66. To reduce cost and packaging complexities, it may be desired to combine the power conversion module 86 and the DC/DC converter module 72 into a single, integrated unit. An integrated unit may help to enhance hardware utilization of the components and reduce the number of active and passive components that are present in the vehicle. Further, the integrated unit may have improved cooling capabilities. In addition, the packaging space required may be reduced.

The processes, methods, logic, or strategies disclosed may be deliverable to and/or implemented by a processing device, controller, or computer, which may include any existing programmable electronic control unit or dedicated electronic control unit. Similarly, the processes, methods, logic, or strategies may be stored as data and instructions executable by a controller or computer in many forms including, but not limited to, information permanently stored on various types of articles of manufacture that may include persistent non-writable storage media such as ROM devices, as well as information alterably stored on writeable storage media such as floppy disks, magnetic tapes, CDs, RAM devices, and other magnetic and optical media. The processes, methods, logic, or strategies may also be implemented in a software executable object. Alternatively, they may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure and claims. As previously described, the features of various embodiments may be combined to form further embodiments that may not be explicitly described or illustrated. While various embodiments may have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle power system comprising:
an electric machine configured to drive vehicle wheels;
an inverter; and
a switching arrangement coupled between the electric machine and inverter, and configured to
permit current flow from the inverter to the electric machine with activation of elements of the switching arrangement, and
prevent current flow from the electric machine to the inverter without activation of the elements.

2. The system of claim 1 further comprising a controller programmed to activate the elements during regenerative operation of the electric machine to permit current to flow from the electric machine to the inverter.

3. The system of claim 1 further comprising a controller programmed to operate the inverter and switching arrangement to circulate current between the inverter and electric machine to dissipate charge stored by the inverter.

4. The system of claim 1, wherein the elements are switches.

5. The system of claim 1, wherein the switching arrangement includes diodes that are forward biased from the inverter to the electric machine.

6. The system of claim 1, wherein the switching arrangement is further configured to block back electromagnetic fields associated with the electric machine from the inverter without activation of the elements.

7. A vehicle power system comprising:
an electric machine;
an inverter; and
a plurality of pairs, each including a switch and an associated anti-parallel diode, electrically between the electric machine and inverter, each of the pairs being configured to permit current flow from the inverter to the electric machine with activation of the switch, and to prevent current flow from the electric machine to the inverter without activation of the switch.

8. The system of claim 7, wherein each of the pairs is electrically in series with a phase of the electric machine and a mid-point of a leg of the inverter,

9. The system of claim 7 further comprising a controller programmed to activate the switches during regenerative operation of the electric machine to permit current to flow from the electric machine to the inverter.

10. The system of claim 7 further comprising a controller programmed to operate the inverter and pairs to circulate current between the inverter and electric machine to dissipate charge stored by the inverter.

11. The system of claim 7, wherein the anti-parallel diodes are forward biased from the inverter to the electric machine.

12. The system of claim 7, wherein the pairs are further configured to block back electromagnetic fields associated with the electric machine without activation of the switches.

13. A method for operating a vehicle power system comprising:
by a controller,
permitting activation of switches of a switching arrangement coupled between an electric machine and inverter to permit current flow from the inverter to the electric machine, and
preventing activation of the switches to block back electromagnetic fields associated with the electric machine from the inverter.

14. The method of claim 13, wherein the permitting is responsive to propulsion mode.

15. The method of claim 13, wherein the preventing is responsive to tow mode.

16. The method of claim 13 further comprising permitting activation of the switches to permit current flow from the electric machine to the inverter.
